(19) United States
(12) Patent Application Publication
(10) Pub. No.: US 2022/0383208 A1
(43) Pub. Date: Dec. 1, 2022

(54) RESOURCE AVAILABILITY SYSTEM

(71) Applicant: Citrix Systems, Inc., Fort Lauderdale, FL (US)

(72) Inventor: Manbinder Pal Singh, Coral Springs, FL (US)

(21) Appl. No.: 17/330,773

(22) Filed: May 26, 2021

(51) Int. Cl. G06Q 10/02; G06Q 10/10; G06K 7/14

(52) U.S. Cl. CPC G06Q 10/02; G06Q 10/1095; G06K 7/1417; G06F 1/3265

(57) ABSTRACT

Methods, apparatuses, and systems for contextual resource registration are described herein. A resource, such as a computer, may be registered for use by a user with a mobile device. The resource may be connected to a controller that has an amount of control over the resource. The controller may broadcast its identifying information, such as an Internet protocol (IP) address, to mobile devices in the vicinity. A mobile device may receive the broadcast message and establish a connection with the controller. The controller may determine whether the mobile device is already registered and also whether the corresponding resource is available for registration. The controller may cause the resource to display a digital signage to facilitate registration with the resource.

### FIELD

Aspects described herein generally relate to computing and peripheral devices. More specifically, one or more aspects described herein provide methods, apparatuses, and systems for identification and communication of a device's availability for use.

### BACKGROUND

With the advancement of virtual computing, remote desktop environments, and video teleconferencing, and in view of recent world events, telecommuting is now commonplace. As more people are working from home, there is less of an urgent need to come into a physical office space for work anymore. Thus, assigning various office resources, such as workspaces, desks, and personal computers, to employees on a permanent basis may be less efficient because the average office occupancy rate would be lower in these environments. Instead, many employers are opting for a more flexible working arrangement, where seats and workspaces are dynamically assigned and reserved to employees on a daily or weekly basis rather than being permanently allocated, to increase efficiency and productivity.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

There exists a need then to manage these various types of resources more effectively and make it more convenient for users to identify available resources and reserve them. With current methods of reserving a workstation, for example, users have no means of identifying an unreserved workstation from a reserved one unless they physically turn the unit on. This process may be cumbersome and time-consuming especially if there are a large number of workstations in a given area that are turned off or otherwise in a power saving mode.

To overcome limitations described above, and to overcome other limitations that will be apparent upon reading and understanding the present specification, aspects described herein are directed towards a resource availability system.

According to an example method, a computing device may receive from a mobile device a message identifying the mobile device. The message may be received after entry of the mobile device into an area that includes a plurality of workstations. The plurality of workstations may include at least one first workstation with a display powered off and reserved by another user other than a user of the mobile device. The computing device may determine, based on the message, that the user of the mobile device is trying to reserve a workstation. The computing device may determine to activate one or more workstations of the plurality of workstations based on the received message and a status of the user of the mobile device. Based on this determination, the computing device may initiate activation of at least one second workstation of the plurality of workstations other than the at least one first workstation reserved by the another user. The activation may include causing a display of the at least one second workstation to power on to indicate an availability of the at least one second workstation.

The activation may further include at least one of: causing the at least one second workstation to power on, causing the at least one second workstation to exit power saving mode, or causing the display of the at least one second workstation to exit power saving mode.

The activation may further include causing the display of the at least one second workstation to display a digital signage. The digital signage may include information about reserving the at least one second workstation. The digital signage may include a uniform resource locator (URL) associated with a user interface for reserving the at least one second workstation. The digital signage may include a quick response (QR) code configured to redirect the mobile device to a user interface for reserving the at least one second workstation.

Determining to activate one or more workstations may include sending, to a server, a query regarding the mobile device; and receiving, from the server, a reservation status associated with the user of the mobile device.

The message may further include a reservation status associated with the user of the mobile device. Determining to activate one or more workstation may be based on the reservation status associated with the user of the mobile device.

Initiating the activation may be further based on a determination that the at least one second workstation is available for reservation.

The computing device may further send to the mobile device a reservation status associated with the at least one second workstation.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3A is a block diagram of an example system in which resource management services may manage and streamline access by clients to resource feeds (via one or more gateway services) and/or software-as-a-service (SaaS) applications.

FIG. 3B is a block diagram showing an example implementation of the system shown in FIG. 3A in which various resource management services as well as a gateway service are located within a cloud computing environment.

FIG. 3C is a block diagram similar to that shown in FIG. 3B but in which the available resources are represented by a single box labeled “systems of record,” and further in which several different services are included among the resource management services.

FIG. 3D shows how a display screen may appear when an intelligent activity feed feature of a multi-resource management system, such as that shown in FIG. 3C, is employed.

FIG. 4 depicts an illustrative resource availability system.

FIG. 5 depicts an illustrative flow diagram to determine and communicate an availability of a resource.

FIG. 6 depicts an illustrative floor plan for multiple resources organized into multiple zones.

FIG. 7 depicts an illustrative flow diagram for a method for identification and communication of availability of a resource.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards managing or identifying resources (e.g., computers, etc.) and allowing users with mobile devices to reserve resources. The resources, which may be turned off or in a power saving mode when being idle for an extended time, may be selectively turned on to help the users identify the resources that are freely available for use. Specifically, controllers (e.g., servers, thin clients, or Internet-of-things (IoT) devices) that are linked to their corresponding resources may determine whether a new user is already reserved and also determine whether the corresponding resource is available for use before activating the resource. As a result, a user with a mobile device may find and reserve a resource more seamlessly and more conveniently.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the term “connected” and similar terms, is meant to include both direct and indirect connecting.

Computing Architecture

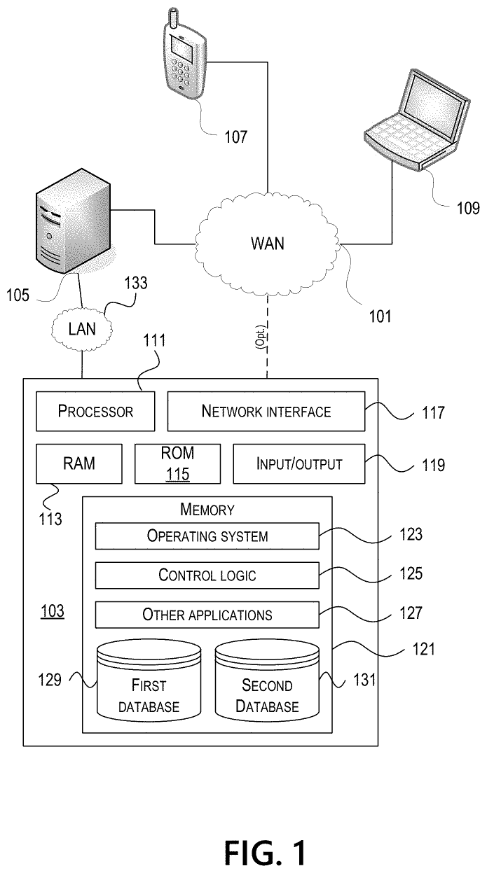

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

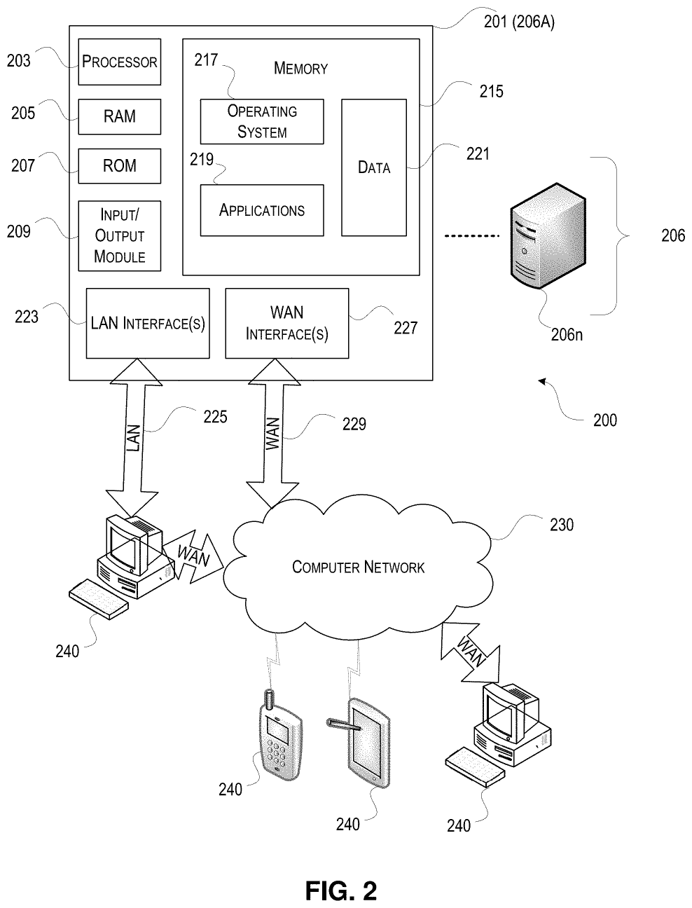

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

Resource Management System

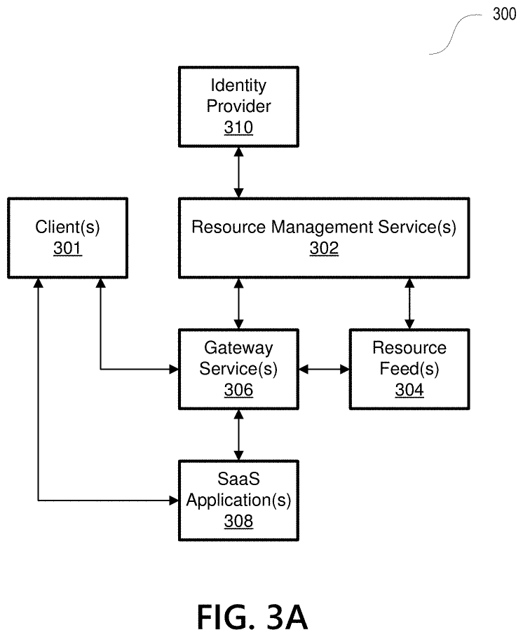

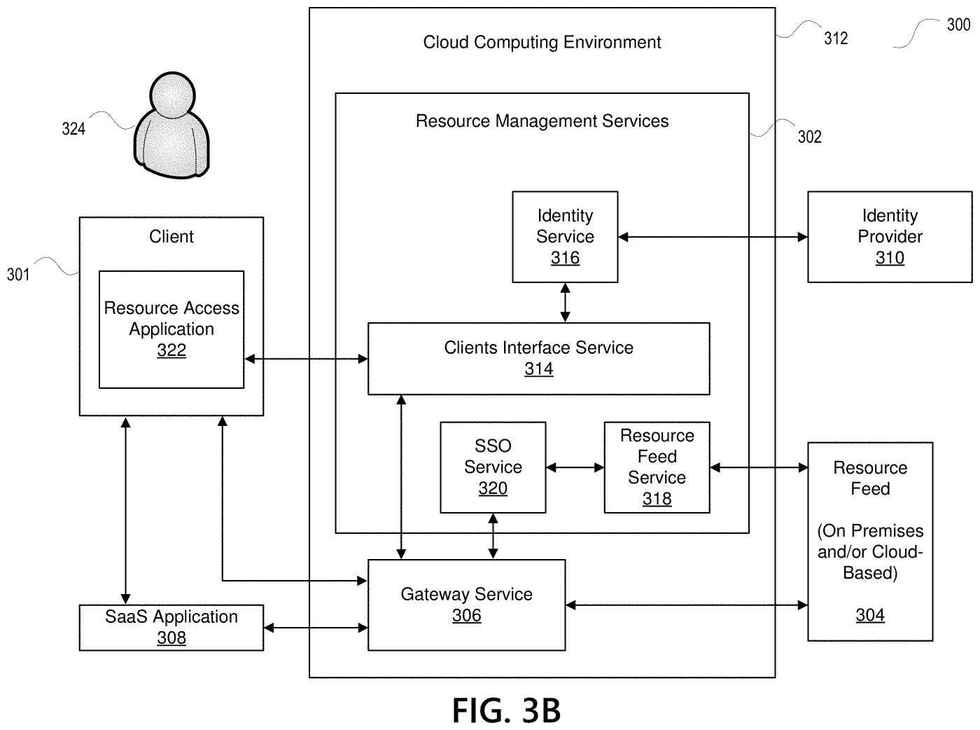

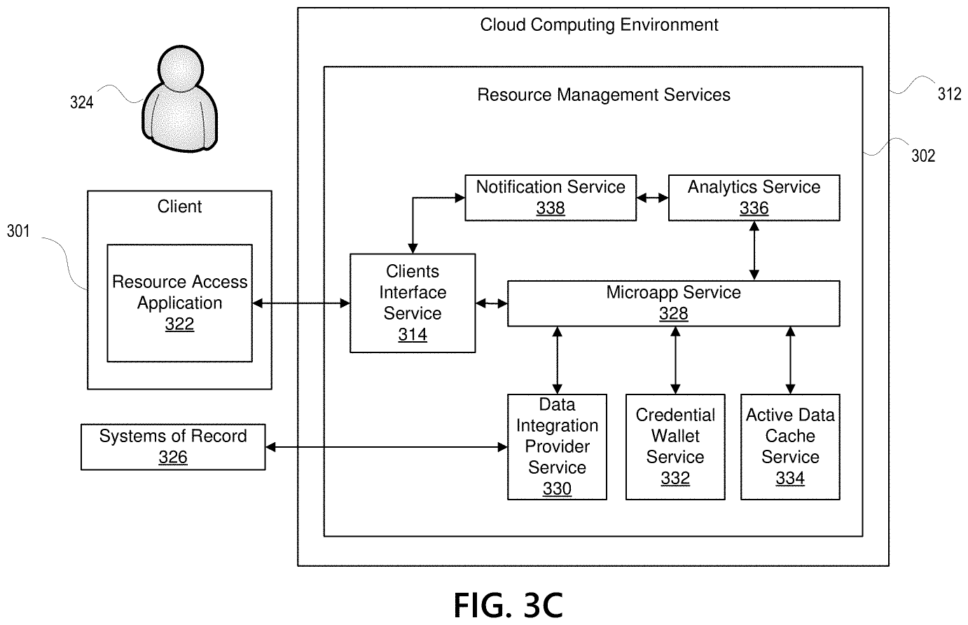

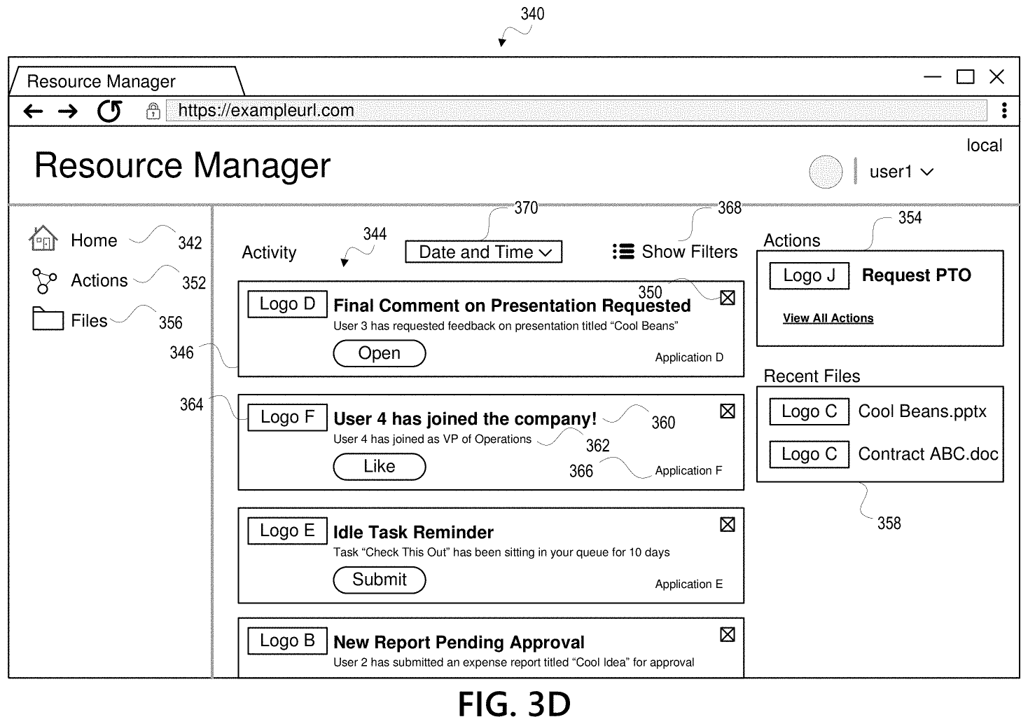

FIG. 3A is a block diagram of an example multi-resource access system 300 in which one or more resource management services 302 may manage and streamline access by one or more clients 301 to one or more resource feeds 304 (via one or more gateway services 306) and/or one or more software-as-a-service (SaaS) applications 308. In particular, the resource management service(s) 302 may employ an identity provider 310 to authenticate the identity of a user of a client 301 and, following authentication, identify one of more resources the user is authorized to access. In response to the user selecting one of the identified resources, the resource management service(s) 302 may send appropriate access credentials to the requesting client 301, and the client 301 may then use those credentials to access the selected resource. For the resource feed(s) 304, the client 301 may use the supplied credentials to access the selected resource via a gateway service 306. For the SaaS application(s) 308, the client 301 may use the credentials to access the selected application directly.

The client(s) 301 may be any type of computing devices capable of accessing the resource feed(s) 304 and/or the SaaS application(s) 308, and may, for example, include a variety of desktop or laptop computers, smartphones, tablets, etc. The resource feed(s) 304 may include any of numerous resource types and may be provided from any of numerous locations. In some embodiments, for example, the resource feed(s) 304 may include one or more systems or services for providing virtual applications and/or desktops to the client(s) 301, one or more file repositories and/or file sharing systems, one or more secure browser services, one or more access control services for the SaaS applications 308, one or more management services for local applications on the client(s) 301, one or more internet enabled devices or sensors, etc. The resource management service(s) 302, the resource feed(s) 304, the gateway service(s) 306, the SaaS application(s) 308, and the identity provider 310 may be located within an on-premises data center of an organization for which the multi-resource access system 300 is deployed, within one or more cloud computing environments, or elsewhere.

FIG. 3B is a block diagram showing an example implementation of the multi-resource access system 300 shown in FIG. 3A in which various resource management services 302 as well as a gateway service 306 are located within a cloud computing environment 312. The cloud computing environment may, for example, include Microsoft Azure Cloud, Amazon Web Services, Google Cloud, or IBM Cloud. It should be appreciated, however, that in other implementations, one or more (or all) of the components of the resource management services 302 and/or the gateway service 306 may alternatively be located outside the cloud computing environment 312, such as within a data center hosted by an organization.

For any of the illustrated components (other than the client 301) that are not based within the cloud computing environment 312, cloud connectors (not shown in FIG. 3B) may be used to interface those components with the cloud computing environment 312. Such cloud connectors may, for example, run on Windows Server instances and/or Linux Server instances hosted in resource locations and may create a reverse proxy to route traffic between those resource locations and the cloud computing environment 312. In the illustrated example, the cloud-based resource management services 302 include a client interface service 314, an identity service 316, a resource feed service 318, and a single sign-on service 320. As shown, in some embodiments, the client 301 may use a resource access application 322 to communicate with the client interface service 314 as well as to present a user interface on the client 301 that a user 324 can operate to access the resource feed(s) 304 and/or the SaaS application(s) 308. The resource access application 322 may either be installed on the client 301, or may be executed by the client interface service 314 (or elsewhere in the multi-resource access system 300) and accessed using a web browser (not shown in FIG. 3B) on the client 301.

As explained in more detail below, in some embodiments, the resource access application 322 and associated components may provide the user 324 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 322 is launched or otherwise accessed by the user 324, the client interface service 314 may send a sign-on request to the identity service 316. In some embodiments, the identity provider 310 may be located on the premises of the organization for which the multi-resource access system 300 is deployed. The identity provider 310 may, for example, correspond to an on-premises Windows Active Directory. In such embodiments, the identity provider 310 may be connected to the cloud-based identity service 316 using a cloud connector (not shown in FIG. 3B), as described above. Upon receiving a sign-on request, the identity service 316 may cause the resource access application 322 (via the client interface service 314) to prompt the user 324 for the user's authentication credentials (e.g., user-name and password). Upon receiving the user's authentication credentials, the client interface service 314 may pass the credentials along to the identity service 316, and the identity service 316 may, in turn, forward them to the identity provider 310 for authentication, for example, by comparing them against an Active Directory domain. Once the identity service 316 receives confirmation from the identity provider 310 that the user's identity has been properly authenticated, the client interface service 314 may send a request to the resource feed service 318 for a list of subscribed resources for the user 324.

In other embodiments (not illustrated in FIG. 3B), the identity provider 310 may be a cloud-based identity service, such as a Microsoft Azure Active Directory. In such embodiments, upon receiving a sign-on request from the client interface service 314, the identity service 316 may, via the client interface service 314, cause the client 301 to be redirected to the cloud-based identity service to complete an authentication process. The cloud-based identity service may then cause the client 301 to prompt the user 324 to enter the user's authentication credentials. Upon determining the user's identity has been properly authenticated, the cloud-based identity service may send a message to the resource access application 322 indicating the authentication attempt was successful, and the resource access application 322 may then inform the client interface service 314 of the successfully authentication. Once the identity service 316 receives confirmation from the client interface service 314 that the user's identity has been properly authenticated, the client interface service 314 may send a request to the resource feed service 318 for a list of subscribed resources for the user 324.

The resource feed service 318 may request identity tokens for configured resources from the single sign-on service 320. The resource feed service 318 may then pass the feed-specific identity tokens it receives to the points of authentication for the respective resource feeds 304. The resource feeds 304 may then respond with lists of resources configured for the respective identities. The resource feed service 318 may then aggregate all items from the different feeds and forward them to the client interface service 314, which may cause the resource access application 322 to present a list of available resources on a user interface of the client 301. The list of available resources may, for example, be presented on the user interface of the client 301 as a set of selectable icons or other elements corresponding to accessible resources. The resources so identified may, for example, include one or more virtual applications and/or desktops (e.g., Citrix Virtual Apps and Desktops™ VMware Horizon, Microsoft RDS, etc.), one or more file repositories and/or file sharing systems (e.g., Sharefile®, one or more secure browsers, one or more internet enabled devices or sensors, one or more local applications installed on the client 301, and/or one or more SaaS applications 308 to which the user 324 has subscribed. The lists of local applications and the SaaS applications 308 may, for example, be supplied by resource feeds 304 for respective services that manage which such applications are to be made available to the user 324 via the resource access application 322. Examples of SaaS applications 308 that may be managed and accessed as described herein include Microsoft Office 365 applications, SAP SaaS applications, Workday applications, etc.

For resources other than local applications and the SaaS application(s) 308, upon the user 324 selecting one of the listed available resources, the resource access application 322 may cause the client interface service 314 to forward a request for the specified resource to the resource feed service 318. In response to receiving such a request, the resource feed service 318 may request an identity token for the corresponding feed from the single sign-on service 320. The resource feed service 318 may then pass the identity token received from the single sign-on service 320 to the client interface service 314 where a launch ticket for the resource may be generated and sent to the resource access application 322. Upon receiving the launch ticket, the resource access application 322 may initiate a secure session to the gateway service 306 and present the launch ticket. When the gateway service 306 is presented with the launch ticket, it may initiate a secure session to the appropriate resource feed and present the identity token to that feed to seamlessly authenticate the user 324. Once the session initializes, the client 301 may proceed to access the selected resource.

When the user 324 selects a local application, the resource access application 322 may cause the selected local application to launch on the client 301. When the user 324 selects a SaaS application 308, the resource access application 322 may cause the client interface service 314 to request a one-time uniform resource locator (URL) from the gateway service 306 as well a preferred browser for use in accessing the SaaS application 308. After the gateway service 306 returns the one-time URL and identifies the preferred browser, the client interface service 314 may pass that information along to the resource access application 322. The client 301 may then launch the identified browser and initiate a connection to the gateway service 306. The gateway service 306 may then request an assertion from the single sign-on service 320. Upon receiving the assertion, the gateway service 306 may cause the identified browser on the client 301 to be redirected to the logon page for identified SaaS application 308 and present the assertion. The SaaS may then contact the gateway service 306 to validate the assertion and authenticate the user 324. Once the user has been authenticated, communication may occur directly between the identified browser and the selected SaaS application 308, thus allowing the user 324 to use the client 301 to access the selected SaaS application 308.

In some embodiments, the preferred browser identified by the gateway service 306 may be a specialized browser embedded in the resource access application 322 (when the resource access application 322 is installed on the client 301) or provided by one of the resource feeds 304 (when the resource access application 322 is located remotely), e.g., via a secure browser service. In such embodiments, the SaaS applications 308 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 301 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 304) for assessment of its security risk by a web filtering service. For approved URLs, the specialized browser may be permitted to access the link. For suspicious links, however, the web filtering service may have the client interface service 314 send the link to a secure browser service, which may start a new virtual browser session with the client 301, and thus allow the user to access the potentially harmful linked content in a safe environment.

In some embodiments, in addition to or in lieu of providing the user 324 with a list of resources that are available to be accessed individually, as described above, the user 324 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 301 to notify a user 324 of something that requires the user's attention (e.g., approval of an expense report, new course available for registration, etc.).

FIG. 3C is a block diagram similar to that shown in FIG. 3B but in which the available resources (e.g., SaaS applications, web applications, Windows applications, Linux applications, desktops, file repositories and/or file sharing systems, and other data) are represented by a single box 326 labeled “systems of record,” and further in which several different services are included within the resource management services block 302. As explained below, the services shown in FIG. 3C may enable the provision of a streamlined resource activity feed and/or notification process for a client 301. In the example shown, in addition to the client interface service 314 discussed above, the illustrated services include a microapp service 328, a data integration provider service 330, a credential wallet service 332, an active data cache service 334, an analytics service 336, and a notification service 338. In various embodiments, the services shown in FIG. 3C may be employed either in addition to or instead of the different services shown in FIG. 3B. Further, as noted above in connection with FIG. 3B, it should be appreciated that, in other implementations, one or more (or all) of the components of the resource management services 302 shown in FIG. 3C may alternatively be located outside the cloud computing environment 312, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 322 without having to launch the native application. The system shown in FIG. 3C may, for example, aggregate relevant notifications, tasks, and insights, and thereby give the user 324 a dynamic productivity tool. In some embodiments, the resource activity feed may be intelligently populated by utilizing machine learning and artificial intelligence (AI) algorithms. Further, in some implementations, microapps may be configured within the cloud computing environment 312, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 3C, the systems of record 326 may represent the applications and/or other resources the resource management services 302 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 302, and in particular the data integration provider service 330, may, for example, support REST API, JSON, OData-JSON, and 6ML. As explained in more detail below, the data integration provider service 330 may also write back to the systems of record, for example, using OAuth2 or a service account.

In some embodiments, the microapp service 328 may be a single-tenant service responsible for creating the microapps. The microapp service 328 may send raw events, pulled from the systems of record 326, to the analytics service 336 for processing. The microapp service may, for example, periodically cause active data to be pulled from the systems of record 326.

In some embodiments, the active data cache service 334 may be single-tenant and may store all configuration information and microapp data. It may, for example, utilize a per-tenant database encryption key and per-tenant database credentials.

In some embodiments, the credential wallet service 332 may store encrypted service credentials for the systems of record 326 and user OAuth2 tokens.

In some embodiments, the data integration provider service 330 may interact with the systems of record 326 to decrypt end-user credentials and write back actions to the systems of record 326 under the identity of the end-user. The write-back actions may, for example, utilize a user's actual account to ensure all actions performed are compliant with data policies of the application or other resource being interacted with.

In some embodiments, the analytics service 336 may process the raw events received from the microapp service 328 to create targeted scored notifications and send such notifications to the notification service 338.

Finally, in some embodiments, the notification service 338 may process any notifications it receives from the analytics service 336. In some implementations, the notification service 338 may store the notifications in a database to be later served in an activity feed. In other embodiments, the notification service 338 may additionally or alternatively send the notifications out immediately to the client 301 as a push notification to the user 324.

In some embodiments, a process for synchronizing with the systems of record 326 and generating notifications may operate as follows. The microapp service 328 may retrieve encrypted service account credentials for the systems of record 326 from the credential wallet service 332 and request a sync with the data integration provider service 330. The data integration provider service 330 may then decrypt the service account credentials and use those credentials to retrieve data from the systems of record 326. The data integration provider service 330 may then stream the retrieved data to the microapp service 328. The microapp service 328 may store the received systems of record data in the active data cache service 334 and also send raw events to the analytics service 336. The analytics service 336 may create targeted scored notifications and send such notifications to the notification service 338. The notification service 338 may store the notifications in a database to be later served in an activity feed and/or may send the notifications out immediately to the client 301 as a push notification to the user 324.

In some embodiments, a process for processing a user-initiated action via a microapp may operate as follows. The client 301 may receive data from the microapp service 328 (via the client interface service 314) to render information corresponding to the microapp. The microapp service 328 may receive data from the active data cache service 334 to support that rendering. The user 324 may invoke an action from the microapp, causing the resource access application 322 to send an action request to the microapp service 328 (via the client interface service 314). The microapp service 328 may then retrieve from the credential wallet service 332 an encrypted Oauth2 token for the system of record for which the action is to be invoked, and may send the action to the data integration provider service 330 together with the encrypted OAuth2 token. The data integration provider service 330 may then decrypt the OAuth2 token and write the action to the appropriate system of record under the identity of the user 324. The data integration provider service 330 may then read back changed data from the written-to system of record and send that changed data to the microapp service 328. The microapp service 328 may then update the active data cache service 334 with the updated data and cause a message to be sent to the resource access application 322 (via the client interface service 314) notifying the user 324 that the action was successfully completed.

In some embodiments, in addition to or in lieu of the functionality described above, the resource management services 302 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 302 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 302 may, for example, parse these requests and respond because they are integrated with multiple systems on the back-end. In some embodiments, users may be able to interact with the virtual assistant through either the resource access application 322 or directly from another resource, such as Microsoft Teams. This feature may allow employees to work efficiently, stay organized, and deliver only the specific information they're looking for.

FIG. 3D shows how a display screen 340 presented by a resource access application 322 (shown in FIG. 3C) may appear when an intelligent activity feed feature is employed and a user is logged on to the system. Such a screen may be provided, for example, when the user clicks on or otherwise selects a “home” user interface element 342. As shown, an activity feed 344 may be presented on the screen 340 that includes a plurality of notifications 346 about respective events that occurred within various applications to which the user has access rights. An example implementation of a system capable of providing an activity feed 344 like that shown is described above in connection with FIG. 3C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 346 to the user concerning actions that the user can take relating to such events. As shown in FIG. 3D, in some implementations, the notifications 346 may include a title 360 and a body 362, and may also include a logo 364 and/or a name 366 of the system or record to which the notification 346 corresponds, thus helping the user understand the proper context with which to decide how best to respond to the notification 346. In some implementations, one of more filters may be used to control the types, date ranges, etc., of the notifications 346 that are presented in the activity feed 344. The filters that can be used for this purpose may be revealed, for example, by clicking on or otherwise selecting the “show filters” user interface element 368. Further, in some embodiments, a user interface element 370 may additionally or alternatively be employed to select a manner in which the notifications 346 are sorted within the activity feed. In some implementations, for example, the notifications 346 may be sorted in accordance with the “date and time” they were created (as shown for the element 370 in FIG. 3D) and/or an “application” mode (not illustrated) may be selected (e.g., using the element 370) in which the notifications 346 may be sorted by application type.

When presented with such an activity feed 344, the user may respond to the notifications 346 by clicking on or otherwise selecting a corresponding action element 348 (e.g., “Approve,” “Reject,” “Open,” “Like,” “Submit,” etc.), or else by dismissing the notification, e.g., by clicking on or otherwise selecting a “close” element 350. As explained in connection with FIG. 3C below, the notifications 346 and corresponding action elements 348 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 346 (e.g., in a separate, pop-up window corresponding to the microapp) by clicking on or otherwise selecting a portion of the notification 346 other than one of the user-interface elements 348, 350. In some embodiments, the user may additionally or alternatively be able to select a user interface element either within the notification 346 or within a separate window corresponding to the microapp that allows the user to launch the native application to which the notification relates and respond to the event that prompted the notification via that native application rather than via the microapp. In addition to the event-driven actions accessible via the action elements 348 in the notifications 346, a user may alternatively initiate microapp actions by selecting a desired action, e.g., via a drop-down menu accessible using the “action” user-interface element 352 or by selecting a desired action from a list 354 of recently and/or commonly used microapp actions. As shown, the user may also access files (e.g., via a Citrix ShareFile™ platform) by selecting a desired file, e.g., via a drop-down menu accessible using the “files” user interface element 356 or by selecting a desired file from a list 358 of recently and/or commonly used files.

Although not shown in FIG. 3D, it should be appreciated that, in some implementations, additional resources may also be accessed through the screen 340 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops™ service) by clicking on or otherwise selecting a “desktops” user-interface element (not shown) to reveal a list of accessible desktops.

The activity feed shown in FIG. 3D provides significant benefits, as it allows a user to respond to application-specific events generated by disparate systems of record without needing to navigate to, launch, and interface with multiple different native applications.

Resource Availability System

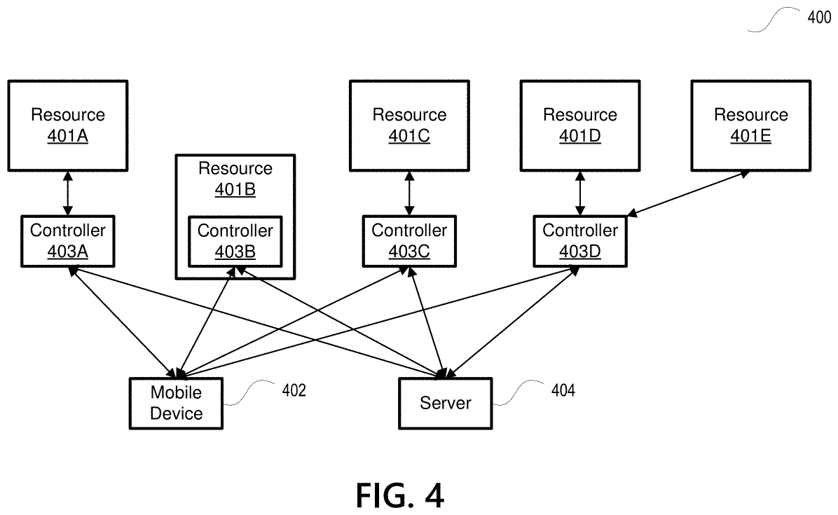

FIG. 4 depicts an illustrative resource availability system. Example system 400 may include one or more resources 401A, 401B, 401C, 401D, 401E (collectively “401”) that may be reserved (e.g., registered booked, assigned, allocated, allotted, etc.) for use via one or more mobile devices 402. Although the example illustrated in FIG. 4 shows four resources 401A, 401B, 401C, 401D, 401E, system 400 may have fewer resources or more resources than five. Moreover, resources 401 may be further divided up into multiple groups or zones. By dividing up resources 401 into groups and/or zones, greater efficiency and flexibility may be achieved. For example, if a building has multiple floors with workstations on each of those multiple floors and a user enters the first floor, only the workstations on the first floor may be selectively activated while workstations on other floors may remain deactivated. Thus, more granular control over resources 401 may be possible. Resources 401 may be any device, object, equipment, or location that may be reserved for use by a user. For example, resource 401 may be a computer, a printer, a scanner, a tool, a desk, a seat, a conference room, a building, a venue, etc. In particular, resource 401 may be an office workspace (e.g., a desktop computer with a keyboard, a mouse, and a monitor). Individual resources 401 may be reserved for a user. That is, a user may reserve one or more resources 401 for exclusive or non-exclusive use in the future. While a resource is being used for exclusive use by one user, the resource may be off-limits to other users. Some resources, such as a printer or a scanner, may be shared by multiple users for non-exclusive use but the number of users who may share the resource at any given time may be limited (e.g., 15 users). Thus, there is a need to efficiently manage and allocate resources 401 for one or more users.

Resources 401 may be paired up with one or more controllers 403A, 403B, 403C, 403D (collectively “403”). Specifically, one controller 403 may control or manage one resource 401 although it may be possible for one controller 403 to control or manage two or more resources 401. Controller 403 may be a computing device, such as any of network nodes 103, 105, 107, 109 in FIG. 1 or computing device 201, server 206, or terminals 240 in FIG. 2. In particular, controller 403 may be a thin client such as a Raspberry Pi produced by Raspberry Pi Foundation of Cambridge, England. Controller 403 may be a desktop computer, a laptop computer, a mobile device, a tablet, a smartphone, etc. Controller 403 may include a wired and/or wireless communication interface such as Wi-Fi, Bluetooth, near-field communication (NFC), radio-frequency identification (RFID), Zigbee, etc. Controllers 403 may communicate with resources 401, other controller(s) 403, and/or server 404. Controller 403 may be located outside resource 401 as a stand-alone device (e.g., controllers 403A, 403C, 403D) or located inside resource 401 (e.g., controller 403B in resource 401B). Controller 403 may comprise software, hardware, or a combination of both. For example, controller 403B may be a software module executing on resource 401B. In other examples, controllers 403A, 403C, 403D may be stand-alone hardware devices that are separate from resources 401A, 401C, 401D, 401E. A controller may be paired with two or more resources, as is the case with controller 403D, which may manage resources 401D and 401E in this example. Controller 403 may be able to control various aspects of corresponding resource 401. For example, controller 403 may be able to activate (e.g., power on or up) or deactivate (e.g., power off or down) resource 401. Controller 403 may, for example turn on the display of resource 401 and cause it to display a digital signage. Controller 403 may wake resource 401 from sleep mode (e.g., power saving mode) or cause resource 401 to enter sleep mode. Controller 403 may keep track of the reservation status of resource 401.

Controllers 403 may communicate with server 404 to exchange data to enable identification and communication of availability of resources. For example, server 404 may be 206 of FIG. 2. Server 404 may include a database for storing information about resources 401A and/or mobile device 402. For example, server 404 may store information about statuses (e.g., reservation statuses) of resources 401. The reservation status may indicate which of resources 401A have been reserved and to which mobile device 402 and/or user, and which of resources 401A are available for reservation and/or use (e.g., not reserved). The reservation status may also indicate which controller 403 and/or resource 401 that mobile device 402 has a reservation with. Controllers 403 may send a query to server 404 regarding reservation status information, and server 404 may send requested information to controllers 403.

A user may use mobile device 402 to reserve one or more resources 401. Each of controllers 403 may broadcast or otherwise communicate a message that includes identifying information (e.g., Internet protocol (IP) address) associated with controller 403. The message may be broadcast or otherwise provided via a wireless communication interface such as Bluetooth, Wi-Fi, NFC, etc. Mobile device 402 may have an application running on it that is monitoring for messages from controllers 403. The application on mobile device 402 may establish a connection with one of controllers 403 (e.g., controller 403A) using the identifying information included in the received message. Mobile device 402 may send to controller 403A data or information (e.g., reservation status information) associated with mobile device 402. Controller 403A may activate corresponding resource 401A. Specifically, controller 403A may determine that its corresponding resource 401A is available for use and also that mobile device 402 is not reserved yet with a particular resource (e.g., seeking reservation). Upon making these determinations, controller 403 may activate resource 401A and cause it to display a digital signage. The digital signage may be, for example, a Quick Response (QR) code that, when scanned, redirects mobile device 402 to a user interface for reserving resource 401A. The digital signage may include other instructions that the user may follow to gain access rights to resource 401A. The digital signage may include a user interface for entering user information and/or reservation information. The digital signage may include information about resource 401A (e.g., future reservation time slots, fees, administrator contact information, etc.).

Resources 401 may be, for example, clients 301 as described with reference to FIGS. 3A-3D. For example, one or more clients 301 may be arrayed in a physical location (e.g., an office building) and a user with mobile device 402 may enter the premises and interact with controllers 403 as described above to make a reservation with one of clients 301. Alternatively, client 301 may correspond to mobile device 402, and a user may use resource access application 322 running on client 301 to interact with controllers 403 to make a reservation for resource 401. For example, the user may use client 301 to interact with the digital signage displayed on resource 401 and also use display screen 340 on client 301 to make such a reservation. Resource management and reservation may be handled by resource management service 302 as shown in FIGS. 3A-3C. For example, the QR code included in the digital signage may include a Universal Resource Locator (URL) for a webpage that is hosted by resource management service 302. Resources 401 may be activated by resource management service 302.

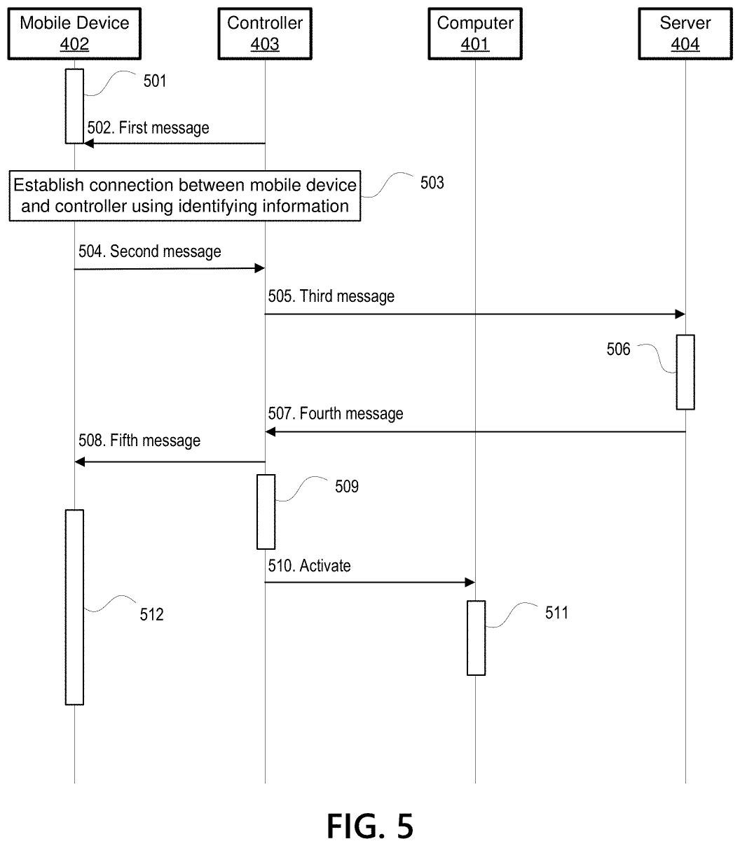

FIG. 5 depicts an illustrative flow diagram to determine and communicate an availability of a resource. Although computer 401 is used as an example of a resource in this and other example embodiments, other types of resources as described herein may also be used instead of or in addition to. Controller 403 may be connected to computer 401 via wired or wireless communication interface. Controller 403 may be uniquely paired to computer 401 for the purpose of managing reservation (e.g., registration) of computer 401 by a mobile device (e.g., mobile device 402). Mobile device 402 may have an application running on it and some or all of the steps that involve mobile device 402 as shown in the illustrate flow diagram of FIG. 5 may be performed by the application running or otherwise executable on mobile device 402. One or more steps illustrated in FIG. 5 may be omitted or performed in any order.

At step 501, mobile device 402 (e.g., one with an application executable thereon) may monitor for any broadcast messages that are sent out by one or more controllers in a vicinity or area about the mobile device 402. In particular, as the user with mobile device 402 moves around in the area, one or more new broadcast messages may be picked up or otherwise received by mobile device 402 as mobile device 402 enters the geofencing range of one or more controllers. A geofence may be a virtual (e.g., invisible) perimeter around controller 403 and may be defined by an administrator and/or the reception range of a communication interface (e.g., Wi-Fi, Bluetooth, NFC, RFID, Zigbee, etc.) The shape of the geofence may be circular (e.g., spherical) or polygonal. At step 502, controller 403 may send a first message to the mobile device 402. The first message may be wirelessly broadcast to mobile device 402 and any other mobile devices located within the geofencing range of wireless communication (e.g., Wi-Fi, Bluetooth, NFC, RFID, Zigbee, etc.). Controller 403 may broadcast messages continuously or periodically (e.g., every 5 seconds). The first message may include identifying information. The identifying information may be, for example, the IP address or the medium access control (MAC) of controller 403. At step 503, mobile device 402 (e.g., an app running on mobile device 402) may establish a connection with controller 403 using the identifying information included in the message from step 502. For example, mobile device 402 may establish a secure connection with controller 403 using the IP address of controller 403. If mobile device 402 has received multiple broadcast messages from multiple controllers, mobile device 402 may establish a connection with a controller with the highest signal strength first.

At step 504, mobile device 402 may send a second message to controller 403. Mobile device 402 may send the second message to controller 403 via the connection previously established at step 503. The second message may include information (e.g., reservation information) indicating whether or not mobile device 402 (and/or its user) has a reservation. Alternatively, if mobile device 402 (and/or its user) already has a reservation (e.g., registered), mobile device 402 may choose to skip steps 503 and 504 such that controller 403 may not need to determine whether to activate computer 401. In other words, if mobile device 402 already has a reservation, it may be assumed that the user of mobile device 402 is not looking to reserve a new resource but is merely moving to the location of the resource that mobile device 402 has already reserved. The second message may include identifying information associated with mobile device 402. For example, the second message may include an identifier (e.g., username, IP address, MAC address, serial number, etc.) associated with mobile device 402.

At step 505, controller 403 may send a third message to server 404. Server 404 may be a backend service that stores information regarding one or more computers, controllers, and/or mobile devices. For example, server 404 may store information about reservation statuses of mobile devices (e.g., has a reservation or not have a reservation; which computer is reserved; etc.), availability statuses of computers (e.g., available or unavailable for reservation), date/time information (e.g., when reservation was made, when reservation expires, etc.), user preferences (e.g., computer preferences, location (e.g., aisle, window, corridor, etc.) preferences, number of monitors, attached peripherals, etc.), etc. The third message may include some or all of the information of the first and/or second messages. For example, the third message may include the identifying information associated with controller 403, identifying information associated with mobile device 402, reservation information, etc. At step 506, server 404 may update its database based on the information contained in the third message. At step 507, server 404 may send a fourth message to controller 403. The fourth message may include any or all of the information stored in the database of server 404. For example, the fourth message may include reservation information and/or reservation information regarding mobile device 402, controller 403, computer 401, and/or other mobile devices, controllers, and computers. Thus, through steps 505-507, the information may be synchronized between controller 403 and server 404. Additionally, server 404 may send an indication to one or more controllers in the area other than controller 403 that mobile device 402 has entered the geofencing range of controller 403. Based on this indication, other controllers may also activate their corresponding computers.

At step 508, controller 403 may send a fifth message to mobile device 402. The fifth message may include some or all of the information contained in the fourth message from step 507. For example, the fifth message may include availability information of computer 401 and/or any other computers in the area.

At step 509, controller 403 may determine whether to activate computer 401. The determination may be based on context information such as whether or not mobile device 402 has a reservation. For example, if mobile device 402 already has a reservation (and thus does not require any further reservation process), then controller 403 may determine not to activate computer 401. Alternatively or additionally, mobile device 402 may determine whether computer 401 is available for reservation. For example, if computer 401 is not available for reservation (e.g., already reserved for another mobile device), then controller 403 may determine not to activate computer 401. Otherwise, at step 510, controller 403 may activate computer 401. Activating computer 401 may include, for example, turning on computer 401, turning on the display (e.g., monitor) of computer 401, waking up computer 401 from a power saving mode (e.g., sleep mode or hibernation mode), and/or display a message. Controller 403 may activate computer 401 by sending a message (e.g., command, instruction, etc.) to computer 401.

At step 511, computer 401 may turn on its display (if not already turned on) and display a digital signage. The digital signage may be a screen that contains information about how the user of mobile device 402 may reserve the computer 401. The digital signage may include, for example, a Universal Resource Locator (URL) for a user interface (e.g., a website) designed to facilitate reservation of computer 401. The digital signage may include a QR code for the URL. The user interface may be hosted by server 404. The user may use mobile device 402 to scan the QR code or manually enter the URL into a web browser to navigate to the user interface and reserve computer 401. Specifically, the user may use mobile device 402 to reserve the use of computer 401 for future use or start using computer 401 immediately upon making the reservation. The user may specify in the user interface the time and date of the use of computer 401 (e.g., until 5:00 pm on the same day). Alternatively, the user may reserve another computer other than computer 401, for example, by scanning a QR code or entering a URL displayed on the other computer. The digital signage may be removed from the display and/or computer 401 may be deactivated (e.g., powered off and/or sometime after the fifth message is received, at step 512 (similar to step 501), mobile device 402 may resume monitoring for broadcast messages from one or more controllers (e.g., if mobile device 402 did not reserve any computers yet).

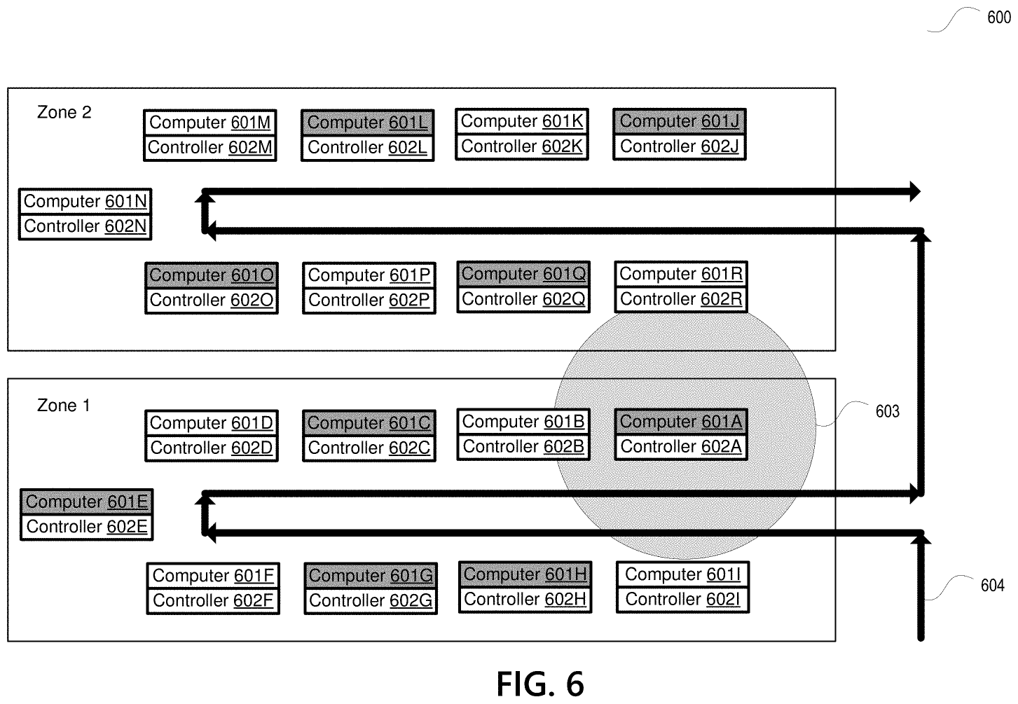

FIG. 6 depicts an illustrative floor plan for multiple resources organized into multiple zones. According to example floor plan 600, multiple resources (e.g., computers) are 601A-601R (collectively “601”) placed in Zone 1 and Zone 2. There may be any number of computers in one or more zones. The computers represented by shaded boxes (e.g., 601A, 601C, 601E, 601G, 601H, 601J, 601L, 601O, 601Q) may be available for reservation while the computers represented by unshaded boxes (e.g., 601B, 601D, 601F, 601I, 601K, 601M, 601N, 601P, 601R) may be unavailable for reservation (e.g., already reserved). Initially, computers 601A-601R may be deactivated before mobile device 604 approaches Zone 1 and/or Zone 2. Zone 1, Zone 2, and any other zones may be located in different areas, on different floors, in different buildings, etc.

Computers 601 may be linked to controllers 602A-602R (collectively “602”). The geofencing range of controller 602A is represented by circle 603. Although not illustrated in FIG. 6, other controllers 602B-602R may have their own respective geofencing ranges. Controllers 602 may continuously or periodically broadcast messages including their respective identifying information (e.g., IP address, etc.). In this example, the movement of a user and her mobile device 604 is represented by a series of arrows. When mobile device 604 enters geofencing range 603 associated with computer 601A and controller 602A, mobile device 604 may receive the broadcast message emanating from controller 602A. Mobile device 604 may establish a connection with controller 602A using the information (e.g., identifying information) contained in the broadcast message. Mobile device 604 may send its reservation information and/or identifying information to controller 602A. The controller may communicate with a server (e.g., backend service) to update reservation and/or availability information. Controller 602A may determine whether to activate computer 601A, for example, based on whether mobile device 604 has a reservation and whether computer 601A is available for reservation. Controller 602A may activate computer 601A and cause it to display a digital signage.

In addition, the server may notify other controllers 602B-602I in Zone 1 regarding the proximity of mobile device 604 to computer 601A. Other controllers 602B-602I in Zone 1 may determine whether to activate corresponding computers 601B-601I. Consequently, controllers 602C, 602E, 602G, 602H may determine to activate corresponding computers 601C, 601E, 601G, 601H. Computers 601A, 601C, 601E, 601G, 601H in Zone 1 may display digital signages with respective URLs and/or QR codes. The user with mobile device 604 may select one of activated computers 601A, 601C, 601E, 601G, 601H and reserve the selected computer by manually entering the corresponding URL or scanning the QR code.

When the user with mobile device 604 leaves Zone 1 (e.g., a predetermined time has elapsed since the last interaction with mobile device 604 and/or controllers 602A-602I have determined that mobile device 604 has left the geofencing ranges of controllers 602A-602I), computers 601A, 601C, 601E, 601G, 601H may stop displaying the digital signages and/or turn off their displays. When the user with mobile device 604 enters Zone 2 and sends a message to one of controllers 602J-602R in response to receiving a broadcast message from one of controllers 602J-602R, controllers 602J-602R and computers 601J-601R in Zone 2 may perform similar procedures as the ones performed by controllers 602A-602I and computers 601A-601I of Zone 1. Specifically, computers 601J, 601L, 601O, 601Q may display their respective digital signages and the user may use mobile device 604 (if not already has reservation) to reserve one of computers 601J-601R.

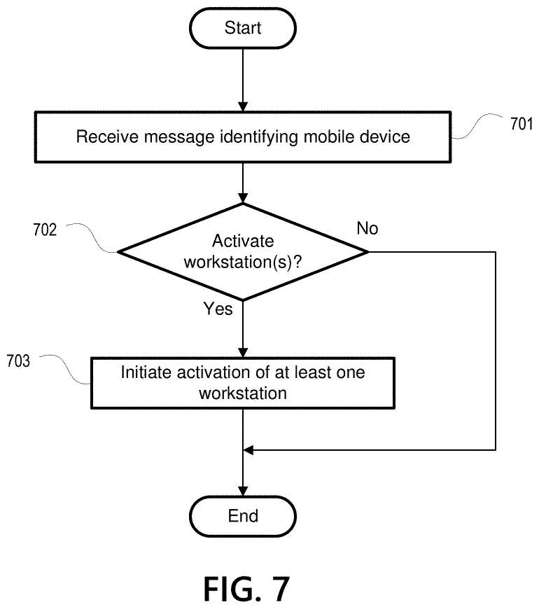

FIG. 7 depicts an illustrative flow diagram for a method or algorithm for identification and communication of availability of a resource (e.g., a workstation). The workstation may be a computer. The workstation may also include a display, a desk, a chair, and/or related peripherals. The steps outlined herein are illustrative and can be implemented in any combination thereof, including combinations that exclude, add, or modify certain steps. At step 701, a computing device may receive a message identifying a mobile device. The computing device may correspond to, for example, controller 303 as shown in FIGS. 3-4 or controller 502 as shown in FIG. 5. The mobile device may correspond to, for example, mobile device 302 as shown in FIGS. 3-4 or mobile device 504 as shown in FIG. 5. The message may be received after entry of the mobile device into an area that includes a plurality of workstations. The message may be received in response to a broadcast message sent by the computing device. The plurality of workstations may include at least one first workstation with a display powered off and reserved by another user other than a user of the mobile device. The message may further include a reservation status associated with the user of the mobile device.

At step 702, the computing device may determine whether to activate one or more workstations of the plurality of workstations. The computing device may make this determination based on the received message and/or a status (e.g., reservation status) of the user of the mobile device. For example, if the user already has a reservation, then the computing device may not activate any workstations (or alternatively, only activate the workstation that the user has a reservation with). In another example, if a workstation is already reserved with the user or a different user, then the computing device may determine not to activate that particular workstation. The computing device may send, to a server, a query regarding the mobile device, and receive, from the server, a reservation status associated with the user of the mobile device. The reservation status may indicate whether the user of the mobile device has a reservation and other information such as which workstation is reserved for use, starting at what time, ending at what time, etc. If the computing device determines not to activate any workstations (702: No), then the process may terminate, or alternatively, return to step 701.

If the computing device determines to activate a workstation (702: Yes), then at step 703, the computing device may initiate activation of least one workstation of the plurality of workstations. Those workstations being activated may be at least one second workstation other than the at least one first workstation reserved by another user. The activation may cause a display of the at least one second workstation to power on to indicate an availability of the at least one second workstation. The at least one second workstation may be, for example, resource 401 as shown in FIGS. 4-5 or computer 601 as shown in FIG. 6. The workstations in this example may be replaced with any other type of resource as disclosed herein other than a computing device. Activation of a workstation may involve at least one of the following: causing the workstation to power on, causing the display of the workstation to power on, causing the workstation to exit power saving mode, and/or causing the display of the workstation to exit power saving mode. Activation of a workstation may involve causing display of the workstation to display a digital signage comprising information about reserving the workstation. The information may include available time slots for reservation. The digital signage may include a uniform resource locator (URL) associated with a user interface for reserving the workstation. The digital signage may include a quick response (QR) code configured to redirect the mobile device to a user interface for reserving the workstation. The user interface may be a webpage. The user may user the digital signage to reserve the workstation. The computing device may send a reservation status associated with one or more workstations to the mobile device.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A computer-implemented method comprising:
receiving, by a computing device, from a mobile device, and after entry of the mobile device into an area that includes a plurality of workstations, a message identifying the mobile device, the plurality of workstations including at least one first workstation with a display powered off and reserved by another user other than a user of the mobile device;
determining, by the computing device, to activate one or more workstations of the plurality of workstations based on the received message and a status of the user of the mobile device; and
initiating, by the computing device and based on the determination, activation of at least one second workstation of the plurality of workstations other than the at least one first workstation reserved by the another user, the activation comprising causing a display of the at least one second workstation to power on to indicate an availability of the at least one second workstation.

2. The method of claim 1, wherein the activation further comprises at least one of:
causing the at least one second workstation to power on,
causing the at least one second workstation to exit power saving mode, or
causing the display of the at least one second workstation to exit power saving mode.

3. The method of claim 1, wherein the activation further comprises causing the display of the at least one second workstation to display a digital signage comprising information about reserving the at least one second workstation.

4. The method of claim 3, wherein the digital signage comprises a uniform resource locator (URL) associated with a user interface for reserving the at least one second workstation.

5. The method of claim 3, wherein the digital signage comprises a quick response (QR) code configured to redirect the mobile device to a user interface for reserving the at least one second workstation.

6. The method of claim 1, wherein the determining to activate one or more workstations comprises:
sending, to a server, a query regarding the mobile device; and
receiving, from the server, a reservation status associated with the user of the mobile device.

7. The method of claim 1, wherein the message further comprises a reservation status associated with the user of the mobile device, and wherein the determining to activate one or more workstation is based on the reservation status associated with the user of the mobile device.

8. The method of claim 1, wherein the initiating the activation is further based on a determination that the at least one second workstation is available for reservation.

9. The method of claim 1, further comprising sending, by the computing device to the mobile device, a reservation status associated with the at least one second workstation.

10. A computing device comprising:
one or more processors; and
memory storing instructions that, when executed by the one or more processors, cause the computing device to:
receive, from a mobile device and after entry of the mobile device into an area that includes a plurality of workstations, a message identifying the mobile device, the plurality of workstations including at least one first workstation with a display powered off and reserved by another user other than a user of the mobile device;
determine to activate one or more workstations of the plurality of workstations based on the received message and a status of the user of the mobile device; and
initiating, based on the determination, activation of at least one second workstation of the plurality of workstations other than the at least one first workstation reserved by the another user, the activation comprising causing a display of the at least one second workstation to power on to indicate an availability of the at least one second workstation.

11. The computing device of claim 10, wherein the activation further comprises at least one of:
causing the at least one second workstation to power on,
causing the at least one second workstation to exit power saving mode, or
causing the display of the at least one second workstation to exit power saving mode.

12. The computing device of claim 10, wherein the activation further comprises causing the display of the at least one second work station to display a digital signage comprising information about reserving the at least one second workstation.

13. The computing device of claim 12, wherein the digital signage comprises a uniform resource locator (URL) associated with a user interface for reserving the at least one second workstation.

14. The computing device of claim 12, wherein the digital signage comprises a quick response (QR) code configured to redirect the mobile device to a user interface for reserving the at least one second workstation.

15. The computing device of claim 10, wherein the instructions, when executed by the one or more processors, cause the computing device to determine to activate one or more workstations by:
sending, to a server, a query regarding the mobile device; and
receiving, from the server, a reservation status associated with the user of the mobile device.

16. A non-transitory computer-readable medium storing instructions that, when executed by a computing device, cause the computing device to:
receive, from a mobile device and after entry of the mobile device into an area that includes a plurality of workstations, a message identifying the mobile device, the plurality of workstations including at least one first workstation with a display powered off and reserved by another user other than a user of the mobile device;
determine to activate one or more workstations of the plurality of workstations based on the received message and a status of the user of the mobile device; and
initiate, based on the determination, activation of at least one second workstation of the plurality of workstations other than the at least one first workstation reserved by the another user, the activation comprising causing a display of the at least one second workstation to power on to indicate an availability of the at least one second workstation.

17. The non-transitory computer-readable medium of claim 16, wherein the activation further comprises at least one of:
causing the at least one second workstation to power on,
causing the at least one second workstation to exit power saving mode, or
causing the at least one second workstation to exit power saving mode.

18. The non-transitory computer-readable medium of claim 16, wherein the activation further comprises causing the display of the at least one second workstation to display a digital signage comprising information about reserving the at least one second workstation.

19. The non-transitory computer-readable medium of claim 18, wherein the digital signage comprises a uniform resource locator (URL) associated with a user interface for reserving the at least one second workstation.

20. The non-transitory computer-readable medium of claim 18, wherein the digital signage comprises a quick response (QR) code configured to redirect the mobile device to a user interface for reserving the at least one second workstation.
